(19) United States
(12) Patent Application Publication
(10) Pub. No.: US 2014/0111839 A1
(43) Pub. Date: Apr. 24, 2014

(54) DRIVING APPARATUS

(71) Applicant: PIONEER CORPORATION, Kawasaki-shi, Kanagawa (JP)

(72) Inventor: Jun SUZUKI, Fujimino-shi City (JP)

(73) Assignee: PIONEER CORPORATION, Kawasaki-shi, Kanagawa (JP)

(21) Appl. No.: 14/126,546

(22) PCT Filed: Jun. 15, 2011
(86) PCT No.: PCT/JP2011/063680

§ 371 Date: Dec. 26, 2013

(51) Int. Cl. G02B 26/10

(52) U.S. Cl. CPC G02B 26/10
USPC 359/198.1

(57) ABSTRACT

A driving apparatus (100) is provided with: a first base part (110-1); a second base part (110-2); a first elastic part (120a-1, 120b-1); a driven part (130); a second elastic part (120a-2, 120b-2); and an applying part (160) which is configured to apply, to the second base part, an excitation force for rotating the driven part such that the driven part rotates while resonating around the axis along the one direction, at a resonance frequency determined by the second elastic part and the driven part, the applying part applies the excitation force such that the second base part vibrates and deforms in a shape of stationary wave along the another direction and the deformational vibration becomes resonance, the resonance frequency at which the second base part resonates is same as a resonance frequency of the driven part.

### TECHNICAL FIELD

The present invention relates to a driving apparatus such as, for example, a MEMS scanner for rotating a driven object such as a mirror.

### BACKGROUND ART

In various technical fields such as, for example, a display, a printing apparatus, precision measurement, precision processing, and information recording-reproduction, research on a micro electro mechanical system (MEMS) device manufactured by a semiconductor fabrication technology is actively progressing. As the MEMS device as described above, a mirror driving apparatus having a microscopic structure (a light scanner or a MEMS scanner) attracts attention, for example, in a display field in which images are displayed by scanning a predetermined screen area with which enters from a light source, or in a scanning field in which a predetermined screen area is scanned with light and image information is read by receiving reflected light.

There is known a mirror driving apparatus which is provided with: a fixed main body to be a base; a mirror capable of rotating around a predetermined central axis; and a torsion bar (a torsion member) for connecting or joining the main body and the mirror (refer to a patent document 1).

### PATENT DOCUMENT

Patent document 1: Published Japanese translation of a PCT application (Tokuhyo) No. 2007-522529

### DISCLOSURE OF INVENTION

### Subject to be Solved by the Invention

In the mirror driving apparatus having such a configuration, it is general that the mirror is driven by using a coil and a magnet. As one example of such a configuration, for example, there is listed a configuration in which the coil is directly attached to the mirror. In this case, due to an interaction between a magnetic field of the magnet and a magnetic field generated by applying an electric current to the coil, a force in a rotational direction is applied to the mirror, resulting in the rotation of the mirror. On the other hand, there is listed a configuration in which the coil is attached to the base which supports (sustains) the mirror, instead of the configuration in which the coil is directly attached to the mirror. Moreover, there is listed a configuration in which the mirror is driven by using piezoelectric force derived from a piezoelectric element or electrostatic force derived from an electrode(s), instead of the configuration in which the mirror is driven by using the coil and the magnet (i.e. electromagnetic force).

For the conventional mirror driving apparatus as described above, it is therefore an object of the present invention to provide a driving apparatus (i.e. MEMS scanner) which is capable of realizing electric power saving by increasing sensitivity in rotating the mirror (i.e. magnitude or amplitude of the rotation of the mirror with respect to a unit electric power which generates the electromagnetic force, the piezoelectric force, the electrostatic force or the like).

The above object of the present invention can be achieved by a driving apparatus provided with: a first base part; a second base part which is surrounded by the first base part; a first elastic part which connects the first base part and the second base part and which has elasticity for rotating the second base part around an axis along another direction; a driven part which is able to rotate; a second elastic part which connects the second base part and the driven part and which has elasticity for rotating the driven part around an axis along one direction which is different from the another direction; and an applying part which is configured to apply, to the second base part, an excitation force for rotating the driven part such that the driven part rotates while resonating around the axis along the one direction, at a resonance frequency determined by the second elastic part and the driven part, the applying part applying the excitation force such that the second base part vibrates and deforms in a shape of stationary wave along the another direction and the deformational vibration becomes resonance, the resonance frequency at which the second base part resonates is same as a resonance frequency of the driven part.

### BRIEF DESCRIPTION OF DRAWINGS

FIG. 1 is a plan view conceptually illustrating a configuration of a driving apparatus in a first example.

FIG. 2 is a plane perspective view illustrating a configuration of a rear side of a second base (specifically, an opposite side of the second base illustrated in FIG. 1).

FIG. 3 is a plan view conceptually showing an aspect of operation performed by the driving apparatus in the first example.

FIG. 4 is a plan view for explaining a non-directional force caused by microvibration applied from a driving source part.

FIG. 5 is a side view illustrating an aspect of a deformational vibration of the second base in association with an aspect of the rotation of the mirror.

FIG. 6 is a side view illustrating an aspect of a deformational vibration of the second base in association with an aspect of the rotation of the mirror.

FIG. 7 is a plan view conceptually illustrating a configuration of a driving apparatus in a second example.

FIG. 8 is a plan view conceptually illustrating one example of a configuration of a driving apparatus in a third example.

### BEST MODE FOR CARRYING OUT THE INVENTION

Hereinafter, as the best mode for carrying out the present invention, an explanation will be given to an embodiment of the driving apparatus in order.

A driving apparatus in the embodiment is provided with: a first base part; a second base part which is surrounded by the first base part; a first elastic part which connects the first base part and the second base part and which has elasticity for rotating the second base part around an axis along another direction; a driven part which is configured to be able to rotate; a second elastic part which connects the second base part and the driven part and which has elasticity for rotating the driven part around an axis along one direction which is different from the another direction; and an applying part which is configured to apply, to the second base part, an excitation force for rotating the driven part such that the driven part rotates while resonating around the axis along the one direction, at a resonance frequency determined by the second elastic part and the driven part, the applying part applying the excitation force such that the second base part vibrates and deforms in a shape of stationary wave along the another direction and the deformational vibration becomes resonance, the resonance frequency at which the second base part resonates being same as a resonance frequency of the driven part.

According to the driving apparatus in the embodiment, the first base part which is a foundation and the second base part which is surrounded by the first base part are connected directly or indirectly by the first elastic part (e.g. a torsion bar described later, etc.) having the elasticity. Moreover, the second base part and the driven part (e.g. a mirror described later, etc.) which is disposed to rotate are connected directly or indirectly by the second elastic part (e.g. a torsion bar described later, etc.) having the elasticity. The second base part is driven to rotate around the axis along the another direction by the elasticity of the first elastic part (e.g. the elasticity capable of rotating the second base part around the axis along the another direction). The driven part is driven to rotate around the axis along the one direction by the elasticity of the second elastic part (e.g. the elasticity capable of rotating the driven part around the axis along the one direction).

In the driving apparatus in the embodiment, in particular, by the operation of the applying part, the excitation force is applied such that the driven part rotates while resonating around the axis along the one direction at the resonance frequency determined by the second elastic part and the driven part. More specifically, the applying part applies the excitation force such that the driven part rotates while resonating around the axis along the one direction at the resonance frequency determined by inertia moment of the driven part around the axis along the one direction (namely, around the rotational axis of the driven part) and a torsion spring constant of the second elastic part.

In addition, in the driving apparatus in the embodiment, the second base part is driven to rotate around the axis along the another direction by the elasticity of the first elastic part (e.g. the elasticity capable of rotating the second base part around the axis along the another direction). Therefore, the driven part which is connected to the second base part via the second elastic part is also driven to rotate around the axis along the another direction. Namely, the driving apparatus in the embodiment can drive the driven part biaxially and rotationally. However, it is natural that the driving apparatus in the embodiment may drive the driven part multiaxially (biaxially or more) and rotationally.

Moreover, in the driving apparatus in the embodiment, the second base part to which the microvibration is applied vibrates and deforms (distorts) in a shape of stationary (ordinary, standing, standard) wave (namely, in a waveform shape of stationary wave) along the another direction. In addition, the deformational vibration (distortional vibration) of the second base part becomes a resonance. Namely, the second base part deforms its external appearance such that one portion of the second base part becomes an antinode of the deformational vibration and another portion of the second base part becomes a node of the deformational vibration. Due to such a deformational vibration of the second base part, the node and the antinode appear along the another direction. The positions of the node and the antinode are substantially fixed, because the deformational vibration of the second base part is performed in accordance with the waveform of the so-called stationary wave.

Moreover, in the driving apparatus in the embodiment, the resonance frequency at which the second base part resonates (namely, a frequency of the deformational vibration of the second base part) becomes same as a resonance frequency of the driven part. Incidentally, the term “same” herein preferably indicates a broad meaning including not only a condition in which both are literally same but also a condition in which some margin is considered such that both are regarded as same substantially. Thus, it is easier to synchronize a cycle of the deformational vibration of the second base part with a cycle of the rotation of the driven part. Therefore, by synchronizing the cycle of the deformational vibration of the second base part with the cycle of the rotation of the driven part, it is possible to rotate the driven part greater, compared to the case where the second base part does not vibrate and deform. More specifically, for example, in the case where the second base part does not vibrate and deform, the rotational amount of the driven part depends on only the rotational amount of the driven part. On the other hand, for example, in the case where the second base part vibrates and deform, the rotational amount of the driven part depends on not only the rotational amount of the driven part but also the vibrating amount of the deformational vibration of the second base part. Therefore, according to the driving apparatus in the embodiment, it is possible to increase the rotational amount of the driven part in the case where the microvibration is applied by using same electric power, compared to the rotational amount of the driven part in the case where the second base part does not vibrate and deform. Namely, it is possible to increase an amplitude (it is a rotational amplitude, and is substantially sensitivity) of the driven part per unit electric power.

Incidentally, as described later by referring to the drawings, a phase of the deformational vibration of the second base part may be same as or opposite to a phase of the driven part.

In one aspect of the driving apparatus in the embodiment, stiffness of one portion of the second base part is larger than stiffness of another one portion of the second base part.

According to this aspect, since the stiffness of the second base part is adjusted, it becomes easier for the second base part to vibrate and deform in the shape of the stationary wave along the another direction.

In an aspect of the driving apparatus in which the stiffness of one portion of the second base part is larger than the stiffness of another one portion of the second base part, flexural stiffness of the second base part along the another direction may become smaller than flexural stiffness of the second base part along the one direction by that the stiffness of one portion of the second base part becomes larger than the stiffness of another one portion of the second base part. In other words, the stiffness of one portion of the second base part may be larger than the stiffness of another one portion of the second base part such that flexural stiffness of the second base part along the another direction is smaller than flexural stiffness of the second base part along the one direction.

By virtue of such a configuration, the flexural stiffness of the second base part along the one direction and the flexural stiffness of the second base part along the another direction are adjusted by adjusting the stiffness of the second base part. Specifically, the flexural stiffness of the second base part along the another direction becomes smaller than the flexural stiffness of the second base part along the one direction. Therefore, it becomes easier for the second base part to bend along the another direction and it becomes relatively difficult for the second base part to bend along the one direction. Thus, it becomes relatively easy for the second base part to vibrate and deform in the shape of the stationary wave along the another direction.

In another aspect of the driving apparatus in the embodiment, mass of one portion of the second base part is larger than stiffness of another one portion of the second base part.

According to this aspect, since the mass of the second base part is adjusted, it becomes easier for the second base part to vibrate and deform in the shape of the stationary wave along the another direction.

In an aspect of the driving apparatus in which the mass of one portion of the second base part is larger than the mass of another one portion of the second base part, flexural stiffness of the second base part along the another direction may become smaller than flexural stiffness of the second base part along the one direction by that the mass of one portion of the second base part may be larger than the mass of another one portion of the second base part. In other words, the mass of one portion of the second base part may be larger than the mass of another one portion of the second base part such that flexural stiffness of the second base part along the another direction is smaller than flexural stiffness of the second base part along the one direction.

By virtue of such a configuration, the flexural stiffness of the second base part along the one direction and the flexural stiffness of the second base part along the another direction are adjusted by adjusting the mass of the second base part. Specifically, the flexural stiffness of the second base part along the another direction becomes smaller than the flexural stiffness of the second base part along the one direction. Therefore, it becomes easier for the second base part to bend along the another direction and it becomes relatively difficult for the second base part to bend along the one direction. Thus, it becomes relatively easy for the second base part to vibrate and deform in the shape of the stationary wave along the another direction

In another aspect of the driving apparatus in the embodiment, the driven part is connected, via the elastic part, to a portion of the second base part which corresponds to a node of the deformational vibration.

According to this aspect, each driven part is connected to the portion of the second base part which corresponds to the node of the deformational vibration. Thus, compared to the case where the second base part does not vibrates and deforms, it is possible to increase the rotational amount of the driven part while a movement of the driven part along a vertical direction (specifically, a direction which is perpendicular to each of the one direction and the another direction and which is perpendicular to a surface of the second base part) is prevented.

In another aspect of the driving apparatus in the embodiment, stiffness of a portion of the second base part which corresponds to the node of the deformational vibration is larger than stiffness of a portion of the second base part other than the node of the deformational vibration.

According to this aspect, it becomes easier for the second base part to vibrate and deform in the shape of the stationary wave along the another direction, by adjusting the stiffness of the second base part.

In another aspect of the driving apparatus in the embodiment, mass of a portion of the second base part which corresponds to the node of the deformational vibration is smaller than mass of a portion of the second base part other than the node of the deformational vibration

According to this aspect, it becomes easier for the second base part to vibrate and deform in the shape of the stationary wave along the another direction, by adjusting the mass of the second base part.

In another aspect of the driving apparatus in the embodiment, the excitation force is non-directional microvibration or anisotropic microvibration as non-directional vibration energy.

According to this aspect, the applying part applies the microvibration to the second base part such that the microvibration is propagated in the inside of a structure which is the second base part. That is, the applying part applies the microvibration which is propagated in the inside of the structure, as excitation energy (in other words, wave energy) for rotating the driven part, instead of applying a force directly distorting or twisting the second base part. In other words, the applying part in the embodiment applies the microvibration which is propagated as energy (in other words, as energy for developing a force of “vibration” without changing the force to vibration) in the inside of the structure, as wave energy for rotating the driven part. The microvibration (in other words, wave energy propagated in the inside of the structure) is a non-directional force at least when being propagated in the inside of the structure. In other words, the wave energy propagated in the inside of the second base part as the microvibration is propagated in an arbitrary direction in the inside of the second base part. As a result, the microvibration is transmitted as the wave energy from the structure such as, for example, the second base part to the second elastic part (and further from the second base part via the second elastic part to the driven part). After that, the microvibration (in other words, wave energy) propagated in the inside of the structure vibrates the second elastic part in a direction according to the elasticity of the second elastic part or rotates the driven part around the axis along the direction according to the elasticity of the second elastic part. In other words, the wave energy can be extracted as vibration along all directions without limiting the direction of the microvibration. In other words, the wave energy propagated in the inside of the second base part can be extracted to the exterior in a form of vibration (more specifically, resonance), resulting in the rotation of the driven part.

Here, if the driven part is driven to rotate by applying a so-called directional force (e.g. if the second base part is greatly distorted or twisted along a rotational direction of the driven part and the distortion is directly applied to the second elastic part and the driven part to rotate the driven part), the applying part needs to apply a directional force for rotating the driven part around the axis along the one direction (i.e. a directional force for distorting or twisting the structure such as the second base part along the rotational direction which is around the axis along the one direction). Thus, the placement position of the applying part needs to be appropriately set such that the directional force can be applied. In other words, if the directional force is applied, the placement position of the applying part is limited depending on a direction of acting the force.

In the embodiment, however, since the non-directional force caused by the microvibration is applied, the placement position of the applying part is no longer limited. In other words, the application of the non-directional force caused by the microvibration does not cause such a situation that the placement position of the applying part is limited depending on the rotational direction of the driven part. That is, regardless of the placement position of the applying part, the microvibration (i.e. the non-directional force) applied from the applying part allows the driven part to rotate around the axis along the one direction, using the elasticity of the second elastic part. This makes it possible to relatively increase the degree of freedom in the design of the driving apparatus.

According to this aspect, the wave energy propagated in the inside of the second base part as the non-directional microvibration or anisotropic microvibration can be propagated in an arbitrary direction in the inside of the second base part. Incidentally, the “non-directional microvibration” or the “anisotropic microvibration” may be the microvibration along a direction which has no correlation with the rotational direction of the driven part. As a result, the wave energy can be extracted as vibration along all directions without limiting the direction of the microvibration. In other words, the wave energy propagated in the inside of the second base part can be extracted to the exterior in a form of vibration (more specifically, resonance), resulting in the rotation of the driven part.

In an aspect of the driving apparatus in which the excitation force is the non-directional microvibration or the anisotropic microvibration as non-directional vibration energy, the applying part may be configured to apply the microvibration which is caused by a force acting along a direction that is different from a direction of the rotation around the axis along the one direction.

According to this aspect, when applying the microvibration, the applying part firstly generates the force acting in the direction different from the direction of the rotation around the axis along the one direction (i.e. the direction of the rotation of the driven part). This force becomes the microvibration (in other words, wave energy) and is applied to the second base part, as explained in detail using the drawings later. In other words, it is possible to apply the microvibration caused by the force acting along the direction different from the direction of the rotation around the axis along the one direction (in other words, the microvibration or wave energy caused by converting the force). Therefore, it is possible to preferably receive the various effects described above.

In an aspect of the driving apparatus in which the excitation force is the non-directional microvibration or the anisotropic microvibration as non-directional vibration energy, the applying part is configured to apply the microvibration which is caused by a force acting along a direction along a surface of the driven part which is in a static condition.

According to this aspect, when applying the microvibration, the applying part firstly generates the force acting along the direction along the surface of the driven part (i.e. the force acting along an in-plane direction) which is in the static condition (in other words, in an initial placement condition). This force becomes the microvibration (in other words, wave energy) and is applied to the second base part, as explained in detail using the drawings later. In other words, it is possible to apply the microvibration caused by the force acting along the direction along the surface of the driven part which is in the static condition (in other words, the microvibration or wave energy caused by converting the force). Therefore, it is possible to preferably receive the various effects described above.

In an aspect of the driving apparatus in which the excitation force is the non-directional microvibration or the anisotropic microvibration as non-directional vibration energy, the applying part is configured to apply, to the second base part, the excitation force for rotating the second base part around the axis along the another direction and for rotating the driven part such that the driven part rotates while resonating around the axis along the one direction, at a resonance frequency determined by the second elastic part and the driven part.

According to this aspect, by the operation of the applying part, the microvibration is applied such that the second base part (in other words, the driven part supported by the second base part) rotates around the axis along the another direction. At the same time, this microvibration makes the driven part rotate while resonating around the axis along the one direction at the resonance frequency determined by the second elastic part and the driven part. Namely, in this aspect, the microvibration for performing the biaxial rotational drive of the driven part is applied from same applying part (in other word, single applying part).

Here, if the biaxial rotational drive of the driven part is performed by applying a so-called directional force (e.g. if the first base part and/or the second base part are/is greatly distorted or twisted along the rotational direction of the driven part and the distortion is directly applied to the first elastic part, the second elastic part and/or the driven part to perform the biaxial rotational drive of the driven part), one applying part needs to apply a directional force for rotating the driven part around the axis along the one direction (i.e. a directional force for distorting or twisting the structure such as the second base part along the direction of the rotation around the axis along the one direction). Another applying part also needs to apply a directional force for rotating the driven part around the axis along the another direction (i.e. a directional force for distorting or twisting the structure such as the first base part and/or the second base part along the direction of the rotation around the axis along the another direction). That is, in the case where the biaxial rotational drive of the driven part is performed by applying the directional force, usually, the driving apparatus needs to be provided with two or more applying parts (in other words, two or more driving sources). In other words, in the case where the biaxial rotational drive of the driven part is performed by applying the directional force, the driving apparatus needs to be provided with two or more applying parts (i.e. two or more driving sources), because one applying part can apply only a force that acts along single direction.

In this aspect, however, the biaxial rotational drive of the driven part can be performed by applying the non-directional force caused by the microvibration. Here, since the non-directional force caused by the microvibration is applied, the microvibration applied from one applying part allows the driven part to rotate around the axis along the one direction and allows the driven part to rotate around the axis along the another direction, using the elasticity of the first elastic part and the second elastic part (i.e. the elasticity for rotating the driven part around the axis along the one direction and the elasticity for rotating the driven part around the axis along the another direction). In other words, in this aspect, even in the case of the biaxial rotational drive of the driven part, it is not always necessary to provide two applying parts. Thus, by using a single applying part (in other words, a single driving source), the microvibration for performing the biaxial rotational drive of the driven part can be applied.

In addition, even if a force acting along two directions can be applied from one applying part, in the case where the biaxial rotational drive of the driven part is performed by applying the directional force, it is eventually necessary to apply a force having components acting along the two directions (i.e. a directional component force for rotating the driven part around the axis along the one direction and a directional component force for rotating the driven part around the axis along the another direction). In this aspect, however, since the non-directional force caused by the microvibration is applied as the wave energy, there is no need to apply the force with considering a direction of acting the force, which is also advantageous.

These operation and other advantages in the embodiment will become more apparent from the examples explained below.

As explained above, according to the driving apparatus in the embodiment is provided with: the first base part; the second base part; the first elastic part; the driven part; the second elastic part; and the applying part, the applying part applies the microvibration such that the second base part vibrates and deform in a shape of stationary wave along the another direction and the deformational vibration becomes resonance, the resonance frequency at which the second base part resonates is same as a resonance frequency of the driven part. Therefore, the driven part can be rotated appropriately.

### EXAMPLES

Hereinafter, with reference to the drawings, examples of the driving apparatus will be explained. Incidentally, hereinafter, an explanation will be given to an example in which the driving apparatus is applied to a MEMS scanner.

### (1) First Example

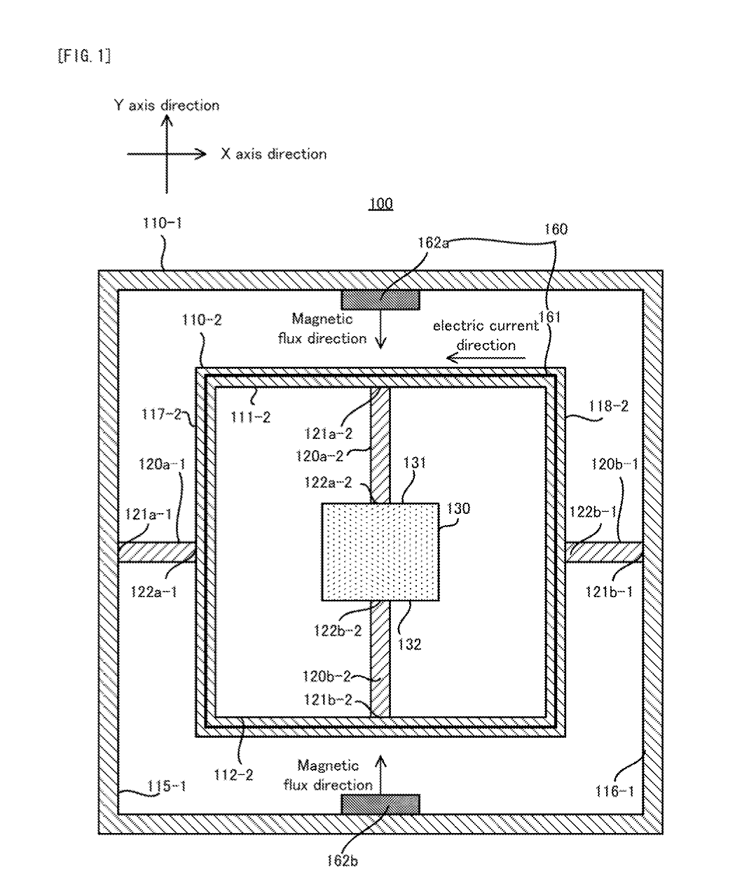

Firstly, with reference to FIG. 1 to FIG. 6, a first example of the MEMS scanner will be explained.

(1-1) Basic Configuration

Firstly, with reference to FIG. 1, a basic configuration of a MEMS scanner 100 in the first example will be explained. FIG. 1 is a plan view conceptually illustrating the basic configuration of the MEMS scanner 100 in the first example.

As shown in FIG. 1, the MEMS scanner 100 in the first example is provided with: a first base 110-1; first torsion bars 120a-1 and 120b-1; a second base 110-2; second torsion bars 120a-2 and 120b-2; a mirror 130; and a driving source part 160.

The first base 110-1 has a frame shape with a space therein. In other words, the first base 110-1 has a frame shape having two sides extending along the Y axis direction in FIG. 1 and two sides extending along the X axis direction (i.e. an axial direction perpendicular to the Y axis) in FIG. 1 and having a space surrounded by the two sides extending along the Y axis direction and the two sides extending along the X axis direction. In an example shown in FIG. 1, the first base 110-1 has, but not limited to, a square shape. For example, the first base 110-1 may have another shape (e.g. rectangular shape such as an oblong, a circular shape, etc.). Moreover, the first base 110-1 is a structure which is the foundation of the MEMS scanner 100 in the first example and is preferably fixed to a not-illustrated substrate or support member (in other words, is fixed in the inside of a system which is the MEMS scanner 100).

Incidentally, FIG. 1 illustrates the example in which the first base 110-1 has the frame shape, but obviously the first base 110-1 may have another shape. For example, the first base 110-1 may have a U shape in which one portion of the sides is open. Alternatively, for example, the first base 110-1 may have a box shape with a space therein. In other words, the first base 110-1 may have a box shape having two surfaces distributed on a plane defined by the X axis and the Y axis, two surfaces distributed on a plane defined by the X axis and the not-illustrated Z axis (i.e. the axis perpendicular to both the X axis and the Y axis), and two surfaces distributed on a plane defined by the Y axis and the not-illustrated Z axis, and having a space surrounded by the six surfaces. Alternatively, the shape of the first base 110-1 may be arbitrarily changed depending on an arrangement aspect of the mirror 130.

The first torsion bar 120a-1 is, for example, an elastic member such as a spring made of silicone, copper alloy, iron-based alloy, other metal, resin, or the like. The first torsion bar 120a-1 is disposed to extend along the X axis direction in FIG. 1. In other words, the first torsion bar 120a-1 has a shape having a long side extending along the X axis direction and a short side extending along the Y axis direction. However, in accordance with a setting situation of a resonance frequency described later, the first torsion bar 120a-1 may have a shape having a short side extending along the X axis direction and a long side extending along the Y axis direction. One end 121a-1 of the first torsion bar 120a-1 is connected to an inner side 115-1 of the first base 110-1. The other end 122a-1 of the first torsion bar 120a-1 is connected to an outer side 117-2 of the second base 110-2 opposed to the inner side 115-1 of the first base 110-1 along the X axis direction.

The first torsion bar 120b-1 is, for example, an elastic member such as a spring made of silicone, copper alloy, iron-based alloy, other metal, resin, or the like. The first torsion bar 120b-1 is disposed to extend along the X axis direction in FIG. 1. In other words, the first torsion bar 120b-1 has a shape having a long side extending along the X axis direction and a short side extending along the Y axis direction. However, in accordance with the setting situation of the resonance frequency described later, the first torsion bar 120b-1 may have a shape having a short side extending along the X axis direction and a long side extending along the Y axis direction. One end 121b-1 of the first torsion bar 120b-1 is connected to an inner side 116-1 of the first base 110-1 opposed to the inner side (in other words, area portion) 115-1 of the first base 110-1 along the X-axis direction (i.e. the inner side 115-1 of the first base 110-1 to which the one end 121a-1 of the first torsion bar 120a-2 is connected). The other end 122b-1 of the first torsion bar 120b-1 is connected to an outer side 118-2 of the second base 110-2 opposed to the inner side 116-1 of the first base 110-1 along the X axis direction.

The second base 110-2 has a frame shape with a space therein. In other words, the second base 110-2 has a frame shape having two sides extending along the Y axis direction in FIG. 1 and two sides extending along the X axis direction (i.e. the axial direction perpendicular to the Y-axis) in FIG. 1 and having a space surrounded by the two sides extending along the Y axis direction and the two sides extending along the X axis direction. In the example shown in FIG. 1, the second base 110-2 has, but not limited to, a square shape. For example, the second base 110-2 may have another shape (e.g. rectangular shape such as an oblong, a circular shape, etc.).

The second base 110-2 is disposed in the space in the inside of the first base 110-1 to be hung or supported by the first torsion bars 120a-1 and 120b-1. The second base 110-2 is configured to rotate around the X axis direction, by the elasticity of the first torsion bars 120a-1 and 120b-1.

Incidentally, FIG. 1 illustrates the example in which the second base 110-2 has the frame shape, but obviously the second base 110-2 may have another shape. For example, the second base 110-2 may have a U shape in which one portion of the sides is open. Alternatively, for example, the second base 110-2 may have a box shape with a space therein. In other words, the second base 110-2 may have a box shape having two surfaces distributed on a plane defined by the X axis and the Y axis, two surfaces distributed on a plane defined by the X axis and the not-illustrated Z axis (i.e. the axis perpendicular to both the X axis and the Y axis), and two surfaces distributed on a plane defined by the Y axis and the not-illustrated Z axis, and having a space surrounded by the six surfaces. Alternatively, the shape of the second base 110-2 may be arbitrarily changed depending on the arrangement aspect of the mirror 130.

The second torsion bar 120a-2 is, for example, an elastic member such as a spring made of silicone, copper alloy, iron-based alloy, other metal, resin, or the like. The second torsion bar 120a-2 is disposed to extend along the Y axis direction in FIG. 1. In other words, the second torsion bar 120a-2 has a shape having a long side extending along the Y axis direction and a short side extending along the X axis direction. However, in accordance with the setting situation of the resonance frequency described later, the second torsion bar 120a-2 may have a shape having a short side extending along the Y axis direction and a long side extending along the X axis direction. One end 121a-2 of the second torsion bar 120a-2 is connected to an inner side 111-2 of the second base 110-2. The other end 122a-2 of the second torsion bar 120a-2 is connected to one side 131 of the mirror 130 opposed to the inner side 111-2 of the second base 110-2 along the Y axis direction.

In the same manner, the second torsion bar 120b-2 is, for example, an elastic member such as a spring made of silicone, copper alloy, iron-based alloy, other metal, resin, or the like. The second torsion bar 120b-2 is disposed to extend along the Y axis direction in FIG. 1. In other words, the second torsion bar 120b-2 has a shape having a long side extending along the Y axis direction and a short side extending along the X axis direction. However, in accordance with the setting situation of the resonance frequency described later, the second torsion bar 120b-2 may have a shape having a short side extending along the Y axis direction and a long side extending along the X axis direction. One end 121b-2 of the second torsion bar 120b-2 is connected to a inner side 112-2 of the second base 110-2 opposed to the inner side (in other words, area portion) 111-2 of the second base 110-2 along the Y axis direction (i.e. the inner side 111-2 of the second base 110-2 to which the one end 121a-2 of the second torsion bar 120a-2 is connected). The other end 122b-2 of the second torsion bar 120b-2 is connected to other side 132 of the mirror 130 opposed to the inner side 112-2 of the second base 110-2 along the Y axis direction.

The mirror 130 is disposed in the space in the inside of the second base 110-2 to be hung or supported by the second torsion bars 120a-2 and 120b-2. The mirror 130 is configured to rotate around the Y axis direction, by the elasticity of the second torsion bars 120a-2 and 120b-2.

The driving source part 160 applies, to the second base 110-2, microvibration required to rotate the mirror 130 around the axis along the Y axis direction. Incidentally, as long as the driving source part 160 can apply the microvibration to the second base 110-2, its arrangement aspect may be determined arbitrarily. Moreover, the driving source part 160 may be configured to apply the microvibration not only to the second base 110-2 but also to other position (for example, the first base 110-1).

More specifically, the driving source part 160 is a driving source part which applies a force caused by an electromagnetic force. The driving source part 160 is provided with: a coil 161 disposed along the frame shape of the second base 110-2; and magnetic poles 162a and 162b fixed to the first base 110-1. In this case, a desired voltage is applied to the coil 161 in desired timing from a not-illustrated driving source part control circuit. The application of the voltage to the coil 161 causes an electric current to flow and causes an electromagnetic interaction between the coil 161 and the magnetic poles 162a and 162b. As a result, an electromagnetic force is generated by the electromagnetic interaction. This electromagnetic force is transmitted to the second base 110-2 as the microvibration.

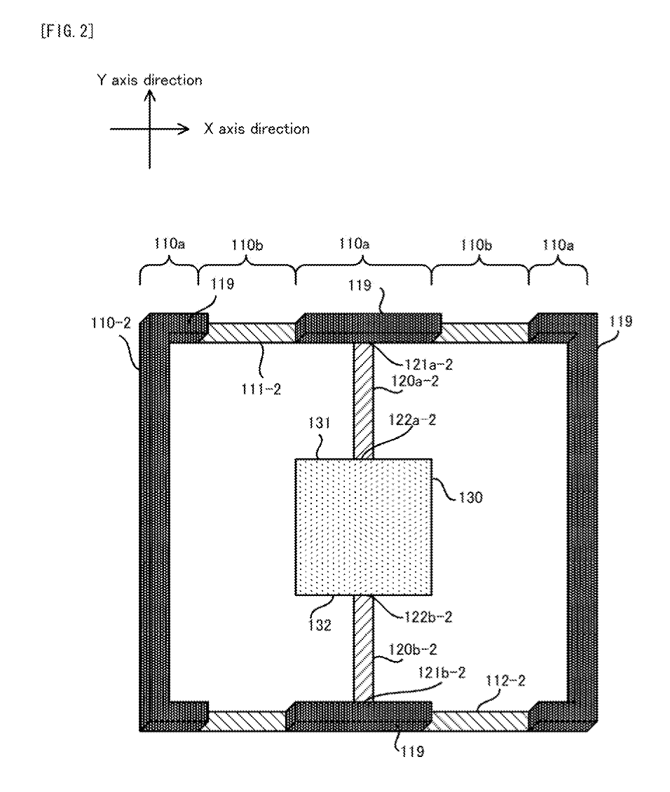

Next, with reference to FIG. 2, an explanation will be given to a configuration of a rear side of the second base 110-2 (specifically, an opposite side of the second base 110-2 illustrated in FIG. 1). FIG. 2 is a plane perspective view illustrating the configuration of the rear side of the second base 110-2 (specifically, an opposite side of the second base 110-2 illustrated in FIG. 1).

As illustrated in FIG. 2, rib (ribs) 119 which protrude(s) from a surface of the second base 110-2 is (are) formed on a partial area (areas) 110a of the frame shape of the second base 110-2. The rib 119 may be formed with it being integrated with the second base 110-2. The rib 119 may be additionally disposed after the second base 110-2 is formed. On the other hand, the rib (ribs) 119 is (are) not formed on another partial area (areas) 110b of the frame shape of the second base 110-2.

Due to the rib 119 illustrated in FIG. 2, stiffness of the partial area 110a of the frame shape of the second base 110-2 becomes larger (higher) than stiffness of the another partial area 110b of the frame shape of the second base 110-2. In other word, it is preferable that rib 119 is formed on the second base 110-2 so as to actualize (realize) such a condition that the stiffness of the partial area 110a of the frame shape of the second base 110-2 becomes larger than the stiffness of the another partial area 110b of the frame shape of the second base 110-2. Namely, it is preferable that the forming position, the size, the mass, the stiffness, the density and the like of the rib 119 are appropriately determined so as to actualize (realize) such a condition that the stiffness of the partial area 110a of the frame shape of the second base 110-2 becomes larger than the stiffness of the another partial area 110b of the frame shape of the second base 110-2.

Alternatively, due to the rib 119 illustrated in FIG. 2, mass (or mass per unit length along a direction of the frame of the second base 110-2) of the partial area 110a of the frame shape of the second base 110-2 becomes larger (heavier) than mass (or mass per unit length along a direction of the frame of the second base 110-2) of the another partial area 110b of the frame shape of the second base 110-2. Alternatively, it is preferable that the rib 119 is formed on the second base 110-2 so as to actualize (realize) such a condition that the mass of the partial area 110a of the frame shape of the second base 110-2 becomes larger than the mass of the another partial area 110b of the frame shape of the second base 110-2. Namely, it is preferable that the forming position, the size, the mass, the stiffness, the density and the like of the rib 119 are appropriately determined so as to actualize (realize) such a condition that the mass of the partial area 110a of the frame shape of the second base 110-2 becomes larger than the mass of the another partial area 110b of the frame shape of the second base 110-2.

Incidentally, it is preferable that the area 110a on which the rib 119 is formed and the area 110b on which the rib 119 is not formed are arranged (or, alternately arranged) along the direction which is perpendicular to the rotational axis (namely, Y axis) of the mirror 130 (namely, along the direction along the X axis).

Incidentally, FIG. 2 illustrates an example in which the rib 119 is formed on the rear side of the second base 110-2. However, the rib 119 may be formed on a front side of the second base 110-2. The rib 119 may be formed on a lateral side of the second base 110-2. Alternatively, a component other than the rib 119 may actualize (realize) such a condition that the stiffness of the partial area 110a of the frame shape of the second base 110-2 becomes larger than the stiffness of the another partial area 110b of the frame shape of the second base 110-2. Alternatively, the component other than the rib 119 may actualize (realize) such a condition that the mass of the partial area 110a of the frame shape of the second base 110-2 becomes larger than the mass of the another partial area 110b of the frame shape of the second base 110-2. For example, the above condition may be realized (actualized) by differentiating the density, the material and the like of the second base 110-2 in the area 110a from those of the second base 110-2 in the area 110b.

(1-2) Operation of MEMS Scanner

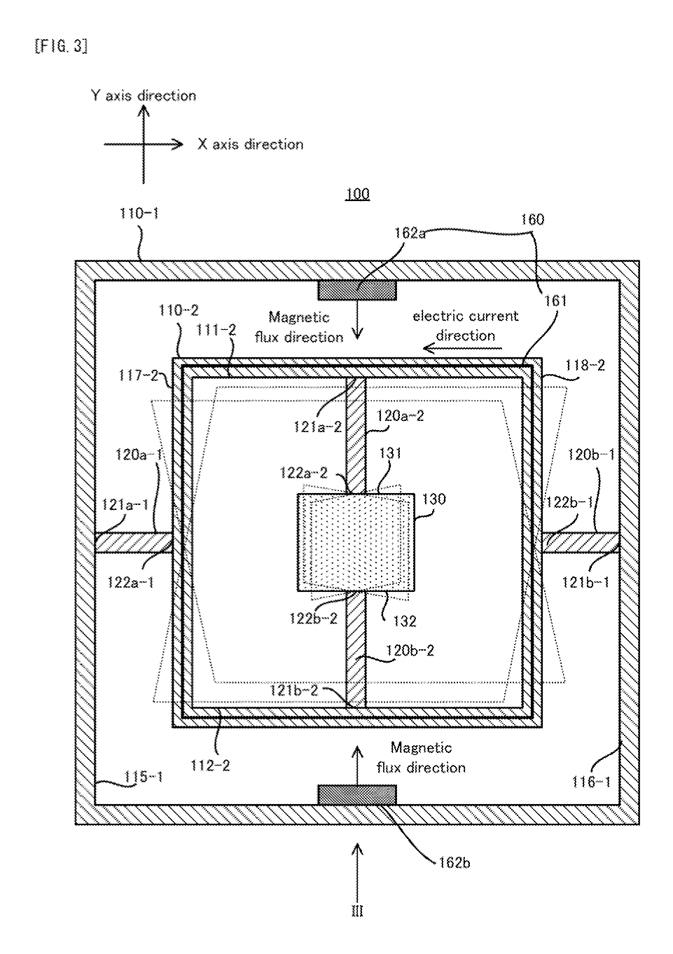

Next, with reference to FIG. 3, an explanation will be given to an aspect of the operation of the MEMS scanner 100 in the first example (specifically, an aspect of the operation of rotating the mirror 130). FIG. 3 is a plan view conceptually showing the aspect of the operation performed by the MEMS scanner 100 in the first example.

In operation of the MEMS scanner 100 in the first example, the desired voltage is applied to the coil 161 in the desired timing from the not-illustrated driving source part control circuit. The application of the voltage to the coil 161 causes an electric current to flow and causes the electromagnetic interaction between the coil 161 and the magnetic poles 162a and 162b. As a result, the electromagnetic force is generated by the electromagnetic interaction. This electromagnetic force is transmitted to the second base 110-2 as the microvibration (or wave energy).

Here, the direction of the electromagnetic force caused by the electromagnetic interaction between the coil 161 and the magnetic pole 162a is a direction from a far side (the far side with respect to the surface of the drawing) toward a near side (the near side with respect to the surface of the drawing) in FIG. 3. The direction of the electromagnetic force caused by the electromagnetic interaction between the coil 161 and the magnetic pole 162b is a direction from the near side toward the far side in FIG. 3. As a result, as illustrated in FIG. 3, the electromagnetic force rotates the first torsion bars 120a-1 and 120b-1 along a direction in accordance with the elasticity of the first torsion bars 120a-1 and 120b-1 themselves, and rotates the second base 110-2. As a result, as illustrated in FIG. 3, the second base 110-2 rotates around the axis along the X axis direction.

Incidentally, the second base 110-2 may repeatedly rotate in a predetermined angular range at a frequency which is same as, lower than or higher than a resonance frequency of the mirror 130 as described later. For example, in the case where the MEMS scanner 100 of the first example is applied to the display (alternatively, HMD (Head Mount Display)), the second base 110-2 may repeatedly rotate at a frequency (for example, 60 Hz) in accordance with a scan period or a frame rate of the display, for example.

Alternatively, the second base 110-2 may repeatedly rotate in the predetermined angular range at a resonance frequency which is determined in accordance with a suspended part including the second base 110-2 and the first torsion bars 120a-1 and 120b-1. Specifically, the second base 110-2 may rotate to resonate at the resonance frequency determined in accordance with the suspended part including the second base 110-2 (in other words, a suspended part including the second base 110-2 which is suspended by the first torsion bars 120a-1 and 120b-1) and the first torsion bars 120a-1 and 120b-1. For example, if the inertia moment, which is around the axis along the X axis, of the suspended part including the second base 110-2 (more specifically, the inertia moment, which is around the axis along the X axis, of the suspended part composed of an entire system, which includes the second base 110-2, to which the mass of each of the mirror 130 and the second torsion bars 120a-2 and 120b-2 provided in the second base 110-2 is added) is I1 and a torsion spring constant of the first torsion bars 120a-1 and 120b-1 on the assumption that the first torsion bars 120a-1 and 120b-1 are regarded as one spring is k1, then, the second base 110-2 rotates around the axis along the X axis direction to resonate at a resonance frequency specified by (1/(2π))×√(k1/I1) (or a resonance frequency which is N multiple or 1/N multiple of (1/(2π))×√(k1/I1) (where N is an integral number of 1 or more)).

Moreover, the direction of the electromagnetic force applied from the driving source part 160 is different from the rotational direction of the mirror 130 (i.e. a direction of the rotation around the Y axis direction). On the other hand, the electromagnetic force is transmitted to the second base 110-2 as the microvibration. More specifically, the driving source part 160 applies the microvibration, which is propagated in the inside of the second base 110-2 while eliminating a distortion along a rotational direction of the second base 110-2), as the wave-energy to the second base 110-2. In other words, the driving source part 160 applies the microvibration which is propagated as energy (in other words, as energy for developing a force) in the inside of the second base 110-2, instead of applying a force for providing the distortion along the rotational direction to the second base 110-2. The microvibration becomes the non-directional force when being propagated in the inside of the second base 110-2. In other words, the wave-energy propagated in the inside of the second base 110-2 as the microvibration is propagated along an arbitrary direction in the inside of the second base 110-2. Moreover, the second base 110-2 to which the microvibration is applied becomes a medium for propagating the microvibration (in other words, the wave-energy) rather than an object in which the second base 110-2 itself vibrates.

As a result, the microvibration applied from the driving source part 160 to the second base 110-2 is transmitted from the second base 110-2 to the second torsion bars 120a-2 and 120b-2. Then, as illustrated in FIG. 3, the microvibration (in other words, the wave-energy) propagated in the inside of the second base 110-2 rotates the second torsion bars 120a-2 and 120b-2 along a direction in accordance with the elasticity of the second torsion bars 120a-2 and 120b-2, and rotates the mirror 130. In other words, the microvibration propagated in the inside of the second base 110-2 appears as the rotation of the second torsion bars 120a-2 and 120b-2 and the rotation of the mirror 130. In other words, the wave-energy can be extracted as vibration along all directions without limiting the direction of the microvibration. Namely, the wave-energy propagated in the inside of the second base 110-2 can be extracted to the exterior in a form of vibration (more specifically, resonance), resulting in the rotation of the mirror 130. As a result, as illustrated in FIG. 3, the mirror 130 rotates around the axis along the Y axis direction. More specifically, the mirror 130 repeatedly rotates in the predetermined angular range of angles at the resonance frequency (in other words, repeats a reciprocating operation of the rotation in the predetermined angular range).

At this time, the mirror 130 rotates to resonate at a resonance frequency determined in accordance with the mirror 130 and the second torsion bars 120a-2 and 120b-2. More specifically, the mirror 130 rotates to resonate at the resonance frequency determined in accordance with an inertia moment of the mirror 130 (more specifically, a suspended part including the mirror 130, and the structure suspended by the second torsion bars 120a-2 and 120b-2) around the axis along the Y axis and a torsion spring constant of the second torsion bars 120a-2 and 120b-2. For example, if the inertia moment, which is around the axis along the Y axis, of the mirror 130 is Ia and the torsion spring constant of the second torsion bars 120a-2 and 120b-2 on the assumption that the second torsion bars 120a-2 and 120b-2 are regarded as one spring is ka, then, the mirror 130 rotates around the axis along the Y axis direction to resonate at a resonance frequency specified by (1/(2π))×√(ka/Ia) (or a resonance frequency which is N multiple or 1/N multiple of (1/(2π))×√(ka/Ia) (where N is an integral number of 1 or more)). Thus, the driving source part 160 applies the microvibration in synchronization with the above resonance frequency such that the mirror 130 resonates at the above resonance frequency.

Moreover, the resonance frequency of the mirror 130 might vary depending on the stiffness and the mass (alternatively, the inertia moment) of the foundation which supports a rotational system including a rotational object being the mirror 130, to be exact. For example, the resonance frequency of the mirror 130 might vary depending on the stiffness and the mass (alternatively, the inertia moment) of first base 110-1, the first torsion bars 120a-1 and 120b-1, the second base 110-2 and the like which support the rotational system including the rotational object being the mirror 130. Thus, the resonance frequency which is obtained by performing a predetermined correction process, in consideration of the stiffness and the mass (alternatively, the inertia moment) of the foundation which supports the mirror 130, with respect to the formula (1/(2π))×√(ka/Ia) (alternatively, parameters ka and Ia which makes this formula) may be used as the actual resonance frequency of the mirror 130.

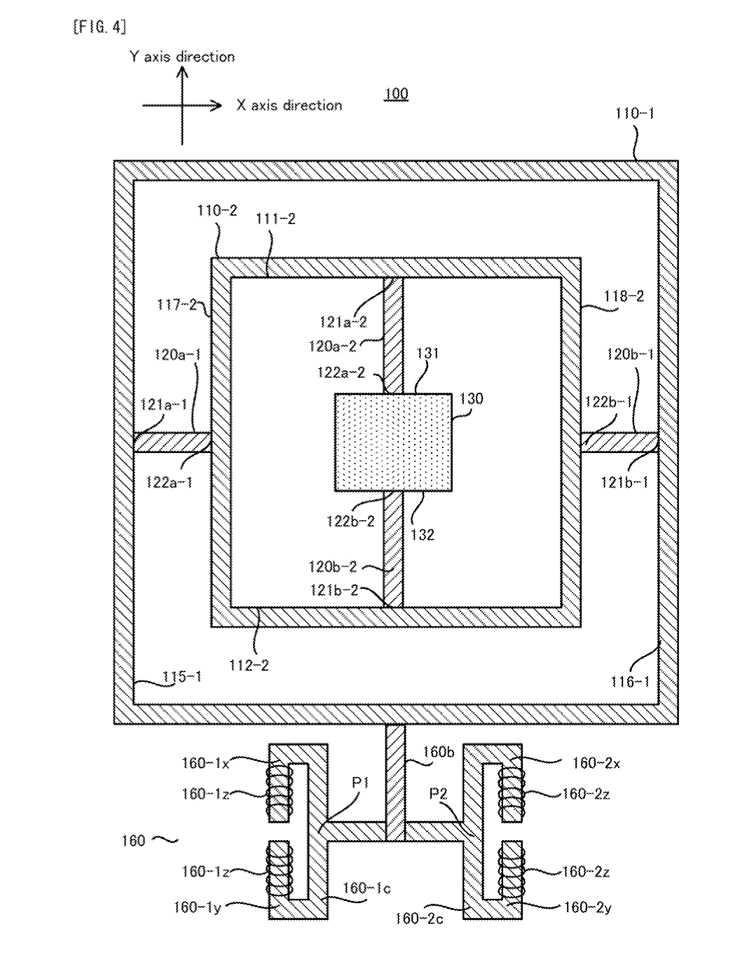

Now, with reference to FIG. 4, the non-directional force caused by the microvibration applied from the driving source part 160 will be further explained. FIG. 4 is a plan view for explaining the non-directional force caused by the microvibration applied from the driving source part 160. Incidentally, for the simple explanation, the following explanation uses a driving force part 160 which is different from the driving force part 160 illustrated in FIG. 1. However, the electromagnetic force applied from the driving source part 160 illustrated in FIG. 1 and the electromagnetic force applied from the driving source part 160 illustrated in FIG. 4 are practically same forces (namely, the non-directional forces).

As illustrated in FIG. 4, the driving source part 160 is provided with: a transmission branch 160b; a first support plate 160-1c which is connected to the first base 110-1 via the transmission branch 160b and which is provided with first branches 160-1x and 160-1y facing to each other along the Y axis direction; a second support plate 160-2c which is connected to the first base 110-1 via the transmission branch 160b and which is provided with second branches 160-2x and 160-2y facing to each other along the Y axis direction; first coils 160-1z which are wound around the first branches 160-1x and 160-1y, respectively; and second coils 160-2z which are wound around the second branches 160-2x and 160-2y, respectively. Moreover, it is assumed that the first branches 160-1x and 160-1y and the second branches 160-2x and 160-2y have the same shape and characteristics. It is assumed that the characteristics (for example, the number of turns) of the coil 160-1z which is wound around the first branch 160-1x are the same as the characteristics (for example, the number of turns) of the coil 160-1z which is wound around the first branch 160-1y. It is assumed that the characteristics (for example, the number of turns) of the coil 160-2z which is wound around the second branch 160-2x are the same as the characteristics (for example, the number of turns) of the coil 160-2z which is wound around the second branch 160-2y.

Here, in a case where an electric current is applied to the coils 160-1z and 160-2z which are wound around the first branches 160-1x and 160-1y and the second branches 160-2x and 160-2y, if a force to be pulled toward the first branch 160-1y and the second branch 160-2y (i.e. a force acting toward a negative direction of the Y axis, i.e., toward the lower side in FIG. 4) is generated for the first branch 160-1x and the second branch 160-2x due to the electromagnetic interaction, a force to be pulled toward the first branch 160-1x and the second branch 160-2x (i.e. a force acting toward a positive direction of the Y axis, i.e., toward the upper side in FIG. 4) is also generated for the first branch 160-1y and the second branch 160-2y. The forces are opposed to each other and have the same magnitude. Thus, the forces do not cause acceleration in the exterior and thereon, and only the microvibration is transmitted to a point P1 of the junction of the first branches 160-1x and 160-1y (in other words, a point P1 on the transmission branch 160b) and a point P2 of the junction of the second branches 160-2x and 160-2y (in other words, a point P2 on the transmission branch 160b). As a result, a force at the points P1 and P2 is not directional. In the same manner, if a force to be separated from the first branch 160-1y and the second branch 160-2y (i.e. a force acting toward the positive direction of the Y axis, i.e., toward the upper side in FIG. 4) is generated for the first branch 160-1x and the second branch 160-2x due to the electromagnetic interaction, a force to be separated from the first branch 160-1x and the second branch 160-2x (i.e. a force acting toward the negative direction of the Y axis, i.e., toward the lower side in FIG. 4) is also generated for the first branch 160-1y and the second branch 160-2y. The forces are opposed to each other and have the same magnitude. Thus, the forces do not cause acceleration in the exterior and thereon, and only the microvibration is transmitted to the point P1 of the junction of the first branches 160-1x and 160-1y and the point P2 of the junction of the second branches 160-2x and 160-2y. As a result, a force at the points P1 and P2 is not directional.

However, according to experiments of the present inventors, it has been found that the microvibration (i.e. the wave-energy and the non-directional force), which is transmitted via the first base 110-1 and the first torsion bars 120a-1 and 120b-1, is propagated in the inside of the second base 110-2 due to the aforementioned configuration, resulting in the rotation of the mirror 130 around the axis along the Y axis direction. In other words, it has been found that the microvibration applied by the driving source part 160 is propagated in the inside of the second base 110-2 as the non-directional force (in other words, the wave-energy) described above, by which the mirror 130 rotates around the axis along the Y axis direction.

As described above, in the first example, the mirror 130 can be rotated around the axis along the Y axis direction such that the mirror 130 resonates at the resonance frequency determined in accordance with the mirror 130 and the second torsion bars 120a-2 and 120b-2. In addition, in the first example, the second base 110-2 can be rotated around the axis along the X axis direction. Here, considering that the mirror 130 is connected to the second base 110-2 via the second torsion bars 120a-2 and 120b-2, the mirror 130 also rotates around the axis along the X axis direction with the rotation of the second base 110-2 around the axis along the X axis direction. As a result, the mirror 130 can be rotated such that the mirror 130 resonates around each of the X-axis and the Y-axis. In other words, in the first example, the mirror 130 rotates around the X axis and the mirror 130 self-resonates around the Y axis.

Here, the “resonance” is a phenomenon in which the repetition of an infinitesimal force causes infinite displacement. Thus, even if a small force is applied in order to rotate the mirror 130, a rotational range of the mirror 130 (in other words, an amplitude along the rotational direction) can be set large. In other words, it is possible to set a force required to rotate the mirror 130 relatively small. It is thus possible to reduce the amount of electric power required to apply the force required to rotate the mirror 130. Therefore, it is possible to rotate the mirror 130 more efficiently, resulting in lower power consumption of the MEMS scanner 100.

In addition, in the first example, the non-directional force is applied.

Here, as a comparative example, a configuration in which the biaxial rotational drive of the mirror 130 is performed by applying a so-called directional force (e.g. a configuration in which the second base 110-2 itself is greatly distorted or twisted along the rotational direction of the mirror 130 and this distortion is directly applied to the second torsion bars 120a-2 and 120b-2 and the mirror 130 to perform the biaxial rotational drive of the mirror 130) will be explained. In this case, one driving source part 160 needs to apply a directional force for rotating the mirror 130 around the axis along the X axis direction (i.e. a directional force for distorting or twisting the first base 110-1 around the axis along the X axis direction). Another driving source part 160 also needs to apply a directional force for rotating the mirror 130 around the axis along the Y axis direction (i.e. a directional force for distorting or twisting the second base 110-2 around the axis along the Y axis direction). That is, in the case where the biaxial rotational drive of the mirror 130 is performed by applying the directional force, the MEMS scanner needs to be provided with two or more driving source parts 160. In other words, in the case where the biaxial rotational drive of the mirror 130 is performed by applying the directional force, since only a force that acts along one direction can be applied from one driving source part 160, and thus, the MEMS scanner needs to be provided with two or more driving source parts 160.

In the first example, however, the biaxial rotational drive of the mirror 130 can be performed by applying the non-directional force caused by the microvibration. Here, since the non-directional force caused by the microvibration is applied, the microvibration (i.e. the non-directional force) applied from one driving source part 160 allows the mirror 130 to rotate around each of the axis along the X axis direction and the axis along the Y axis direction, using the elasticity of the first torsion bars 120a-1 and 120b-1 (i.e. the elasticity for rotating the second base 110-2, which supports the mirror 130, around the axis along the X axis direction) and the elasticity of the second torsion bars 120a-2 and 120b-2 (i.e. the elasticity for rotating the mirror 130 around the axis along the Y axis direction). In other words, in the first example, even in the case of the biaxial rotational drive of the mirror 130, it is not always necessary to provide two driving source parts 160. Thus, by using a single driving source part 160, the non-directional force caused by the microvibration for performing the biaxial rotational drive of the mirror 130 can be applied.

In addition, even if a force acting along two directions can be applied from one driving source part, in the case where the biaxial rotational drive of the mirror 130 is performed by applying the directional force, it is eventually necessary to apply a force having components acting along the two directions (i.e. a directional component force for rotating the mirror 130 around the axis along the X axis direction and a directional component force for rotating the mirror 130 around the axis along the Y axis direction). In the first example, however, since the non-directional force caused by the microvibration is applied as the wave energy, there is no need to apply the force in view of a direction of acting the force, which is also advantageous.

In addition, since the non-directional force caused by the microvibration is applied, the placement position of the driving source part 160 is no longer limited. In other words, the application of the non-directional force caused by the microvibration does not cause such a situation that the placement position of the driving source part 160 is limited depending on the rotational direction of the mirror 130. That is, regardless of the placement position of the driving source part 160, the non-directional force caused by the microvibration applied from the driving source part 160 allows the mirror 130 to rotate around the axis along each of the X axis direction and the Y axis direction, using the elasticity of the first torsion bars 120a-1 and 120b-1 and the elasticity of the second torsion bars 120a-2 and 120b-2. This makes it possible to relatively increase the degree of freedom in the design of the MEMS scanner 100. This is extremely useful in practice for the MEMS scanner which is significantly limited in size or design of each constituent.

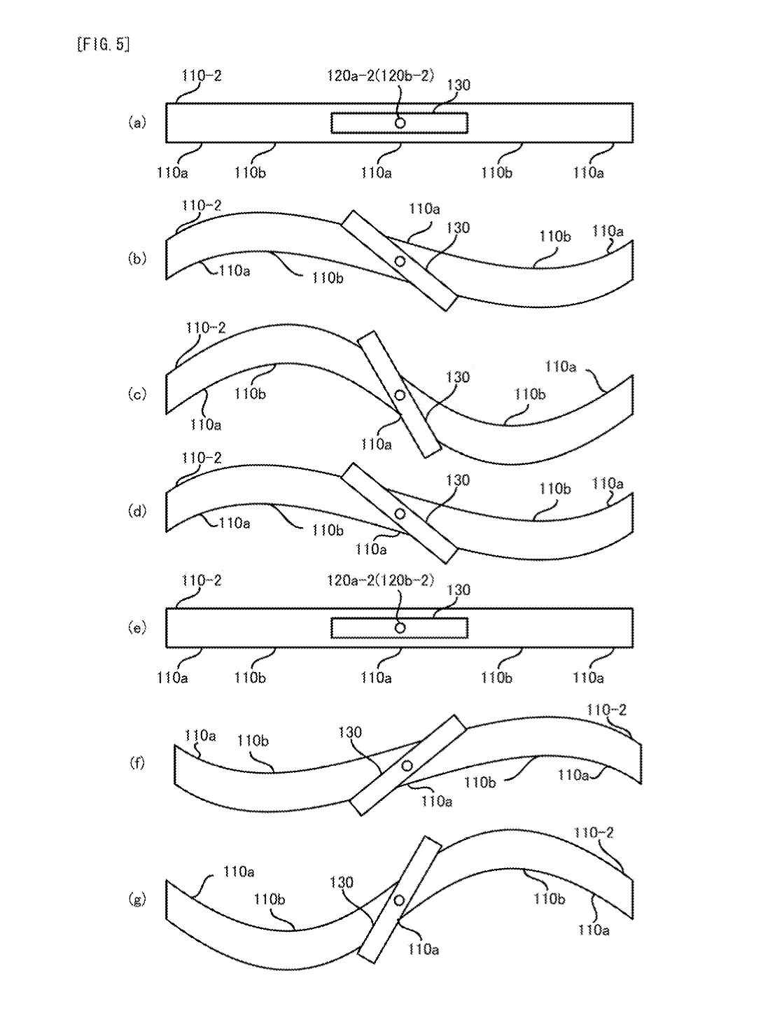

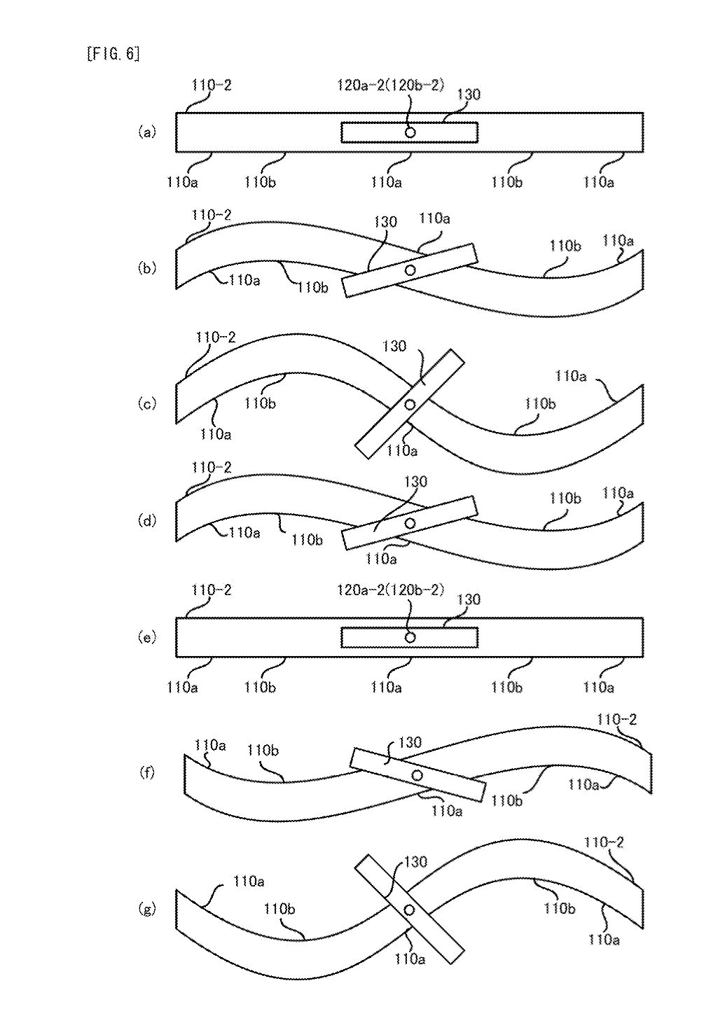

Furthermore, in the first example, the rib (ribs) 119 is (are) formed on the rear side of the second base 110-2. Thus, the second base 110-2 itself vibrates and deforms to wave (undulate), due to the microvibration applied from the driving source part 160. Hereinafter, with reference to FIG. 5 and FIG. 6, an aspect of a deformational vibration of the second base 110-2 will be explained. FIG. 5 and FIG. 6 are side views illustrating the aspect of the deformational vibration of the second base 110-2. Incidentally, FIG. 5 and FIG. 6 illustrate the side views in the case where the second base 110-2 and the mirror 130 are observed from a direction of an arrow “III” illustrated in FIG. 3.

As illustrated in FIG. 5(a), when the microvibration is not applied to the second base 110-2 from the driving source part 160, the second base 110-2 does not vibrates and deforms and the mirror 130 does not rotate.

As illustrated in FIG. 5(b), when the microvibration is applied to the second base 110-2 from the driving source part 160, it is relatively difficult for the area 110a on which the rib 119 is formed to bend due to the microvibration because the stiffness of the area 110a is relatively large and it is relatively easy for the area 110b on which the rib 119 is not formed to bend due to the microvibration because the stiffness of the area 110b is relatively small. As a result, the second base 110-2 vibrates and deforms to wave along the X axis direction while the area 110a on which the rib 119 is formed becomes a node and the area 110b on which the rib 119 is not formed becomes an antinode. More specifically, the second base 110-2 vibrates and deforms while deforming its appearance in a shape of a stationary wave (an ordinary wave, a standing wave, a standard wave) in which a portion on which the rib 119 is formed becomes the node and portion on which the rib 119 is not formed becomes the antinode. Incidentally, in the example illustrated in FIG. 5(b), the second base 110-2 vibrates and deforms to bend from its center. However, the second base 110-2 may vibrate and deform in another deformational mode (for example, a deformational mode which has more nodes).

Incidentally, the deformational vibration of the second base 110-2 in the first example is actualized (realized) by forming the rib(s) 119 on an appropriate position(s). Therefore, it is preferable that the above rib(s) 119 is (are) formed on the appropriate position(s) on the second base 110-2 such that the second base 110-2 vibrates and deforms to wave along the X axis direction while the area 110a on which the rib 119 is formed becomes a node and the area 110b on which the rib 119 is not formed becomes an antinode. At this time, it is preferable that the portion to which the second torsion bars 120a-2 and 120b-2 are connected corresponds to the area 110a. For example, it is preferable that the above rib(s) 119 is (are) formed on the appropriate position(s) on the second base 110-2 such that a portion whose flexural stiffness along the X axis direction is relatively high and a portion whose flexural stiffness along the X axis direction is relatively low are arranged in sequence along the X axis direction. Alternatively, it is preferable that the above rib(s) 119 is (are) formed on the appropriate position(s) on the second base 110-2 such that a portion whose flexural stiffness along the X axis direction is relatively high and a portion whose flexural stiffness along the X axis direction is relatively low are arranged in sequence along the X axis direction, the portion to which the second torsion bars 120a-2 and 120b-2 are connected becomes the area 110a, each of both end edge portions of the second base 110-2 along the X axis direction becomes the area 110a and the other portion becomes the area 110b.

At this time, the second base vibrates and deforms to resonate depending on a cycle of the microvibration applied from the driving source part 160. Here, in the first example, it is preferable that a resonance frequency of the deformational vibration of the second base 110-2 is same as the resonance frequency of the mirror 130. In other words, it is preferable that the characteristic of the second base 110-2 is set such that the second base 110-2 vibrates and deforms at a frequency which is same as the resonance frequency of the mirror 130. For example, it is preferable that the characteristic (for example, the forming position, the size, the mass, the stiffness, the density and the like) of the rib(s) 119 which is formed on the rear side of the second base 110-2 is set such that the second base 110-2 vibrates and deforms at the frequency which is same as the resonance frequency of the mirror 130.

Incidentally, in the case where it is assumed that a structure including the second base 110-2 and the rib(s) 119 is regarded as single spring system, if a mass of this spring system is M and a spring constant of this spring system is k, the resonance frequency of the deformational vibration of the second base 110-2 is specified by the formula (1/(2π))×√(k/M). However, if this spring system is a spring system having one degree of freedom (DOF) in which one mass structure is connected to one spring (in other words, there is one natural frequency and there is one natural vibration mode), the resonance frequency (1/(2π))×√(k/M) can be used. On the other hand, if this spring system is a spring system having two degrees of freedom (DOF) in which two mass structures are connected to one spring, it is preferable that “k” and “M” in the resonance frequency (1/(2π))×√(k/M) and the like are corrected. Incidentally, if the structure including the second base 110-2 and the rib(s) 119 is regarded as the single spring system, the mass M which is added to this spring system and the spring constant k of this spring system are determined in accordance with the stiffness and the mass of the second base 110-2. In the first example, the stiffness and the mass of the second base 110-2 are adjusted by the rib(s) 119. Therefore, the resonance frequency of the second base 110-2 is substantially set in accordance with the characteristic of the above rib(s) 119.

Moreover, the resonance frequency of the deformational vibration of the second base 110-2 might vary depending on the stiffness and the mass (alternatively, the inertia moment) of the foundation which supports a vibrating system including a vibrating object being the second base 110-2, to be exact. For example, the resonance frequency of the deformational vibration of the second base 110-2 might vary depending on the stiffness and the mass (alternatively, the inertia moment) of first base 110-1, the first torsion bars 120a-1 and 120b-1 and the like which support the vibrating system including the vibrating object being the second base 110-2. Thus, the resonance frequency which is obtained by performing a predetermined correction process, in consideration of the stiffness and the mass (alternatively, the inertia moment) of the foundation which supports the second base 110-2, with respect to the formula (1/(2π))×√(k/M) (alternatively, parameters k and M which makes this formula) may be used as the actual resonance frequency of the deformational vibration of the second base 110-2.

Moreover, the resonance of the deformational vibration of the second base 110-2 may be defined by regarding a spring system related to the deformational vibration of the second base 110-2 as a high order resonance mode of the plate element being the second base 110-2, instead of being defined by regarding this spring system as two degrees of freedom in which two mass structures are connected to one spring.

Here, as described above, the microvibration is applied from the driving source part 160 in synchronization with the above resonance frequency such that the mirror 130 resonates at the above resonance frequency. Therefore, due to the application of this microvibration, the second base 110-2 vibrates and deforms to resonate. Namely, as illustrated in FIG. 5(a) to FIG. 5(g) in a time line sequence, the second base 110-2 vibrates and deforms to have an appearance like a stationary wave in which both end edges of the second base 110-2 are fixed (more specifically, a stationary wave in which both end edges and center portion of the second base 110-2 become nodes). Namely, the second base 110-2 has an appearance in which the stationary wave appears along the direction which is perpendicular to the rotational axis of the mirror 130 (namely, along the X axis direction).

Incidentally, FIG. 5(a) to FIG. 5(g) illustrates an example in which a phase of the deformational vibration of the second base 110-2 and a phase of the rotation of the mirror 130 are in phase. According to an experiment by the present inventor and the like, if each of the resonance frequency of the deformational vibration of the second base 110-2 and the resonance frequency of the rotation of the mirror 130 is set to 39 kHz, the phase of the deformational vibration of the second base 110-2 and the phase of the rotation of the mirror 130 becomes in phase. Specifically, conditions illustrated in FIG. 5(a) to FIG. 5(c) are conditions in which the second base 110-2 vibrates and deforms to rotate in a clockwise manner and the mirror 130 rotates in a clockwise manner. Similarly, conditions illustrated in FIG. 5(c) to FIG. 5(g) are conditions in which the second base 110-2 vibrates and deforms to rotate in a counter clockwise manner and the mirror 130 rotates in a counterclockwise manner. Incidentally, the second base 110-2 and the mirror 130 in a condition illustrated in FIG. 5(g) change their states into a condition illustrated in FIG. 5(a) through a condition illustrated in FIG. 5(f). After that, the second base 110-2 and the mirror 130 continue to vibrate and deform or to rotate in accordance with the time line sequence illustrated in FIG. 5(a) to FIG. 5(g).

On the other hand, FIG. 6(a) to FIG. 6(g) illustrates an example in which a phase of the deformational vibration of the second base 110-2 and a phase of the rotation of the mirror 130 are reverse phase. According to an experiment by the present inventor and the like, if each of the resonance frequency of the deformational vibration of the second base 110-2 and the resonance frequency of the rotation of the mirror 130 is set to 53 kHz, the phase of the deformational vibration of the second base 110-2 and the phase of the rotation of the mirror 130 becomes reverse phase. Specifically, conditions illustrated in FIG. 6(a) to FIG. 6(c) are conditions in which the second base 110-2 vibrates and deforms to rotate in a clockwise manner and the mirror 130 rotates in a counterclockwise manner. Similarly, conditions illustrated in FIG. 6(c) to FIG. 6(g) are conditions in which the second base 110-2 vibrates and deforms to rotate in a counter clockwise manner and the mirror 130 rotates in a clockwise manner. Incidentally, the second base 110-2 and the mirror 130 in a condition illustrated in FIG. 6(g) change their states into a condition illustrated in FIG. 6(a) through a condition illustrated in FIG. 6(f). After that, the second base 110-2 and the mirror 130 continue to vibrate and deform or to rotate in accordance with the time line sequence illustrated in FIG. 6(a) to FIG. 6(g).

Since the second base 110-2 vibrates and deforms in such a manner, a rotational amount of the mirror 130 depends on a deformational vibrating amount of the second base 110-2 as well as the rotational amount of the mirror 130 itself. For example, it is assumed that the mirror 130 rotates by an angle θ1 when the microvibration which is generated by a voltage V1 is applied to a comparative MEMS scanner in which the second base 110-2 does not vibrate and deform. In this case, when the microvibration which is generated by the same voltage V1 is applied to the MEMS scanner 100 in the first example in which the second base 110-2 vibrates and deforms, the mirror 130 rotates by the angle θ1 and the second base 110-2 also vibrates and deforms to rotate by an angle θ2. Namely, according to the MEMS scanner 100 in the first example, the rotational amount (rotational angle) of the mirror 130 becomes θ1+θ2 when the microvibration which is generated by the voltage V1 is applied. Therefore, according to the MEMS scanner 100 in the first example, it is possible to increase the rotational amount (rotational angle) of the mirror 130 when the microvibration which is generated by the same voltage V1 is applied, compared to the comparative MEMS scanner. Therefore, it is possible to increase the rotational amount of the mirror 130 (in other words, a rotational sensitivity of the mirror 130) with respect to the same microvibration (or, same voltage or same current for generating the same microvibration).

In addition, the deformation vibration of the second base 110-2 can be actualized (realized) by forming the rib(s) 119 relatively easily. Therefore, it is possible to actualize (realize) the MEMS scanner 100 in the first example relatively easily.

Incidentally, the above first example exemplifies that the microvibration is used as the force for rotating the mirror 130 (namely, the force applied from the driving source part). However, an arbitrary force other than the microvibration may be used as the force for rotating the mirror 130. For example, a directional force which directly acts in a direction of directly rotating the mirror 130 (namely, in the rotational direction of the mirror 130) may be used as the force for rotating the mirror 130, as described in Published Japanese translation of a PCT application (Tokuhyo) No. 2007-522529. Alternatively, a directional force which acts in a direction of indirectly rotating the mirror 130 (namely, the force which generates a distortion vibration of a torsion bar by transmitting expansion and contraction of a piezoelectric element and thus rotates the mirror 130 by using the distortion vibration of the torsion bar) may be used as the force for rotating the mirror 130, as described in Published Japanese translation of a PCT application (Tokuhyo) No. 2007-522529. In other words, a directional force which acts in a direction of directly or indirectly distorting or twisting the first torsion bars 120a-1 and 120b-1 and the second torsion bars 120a-2 and 120b-2 may be used as the force for rotating the mirror 130

### (2) Second Example

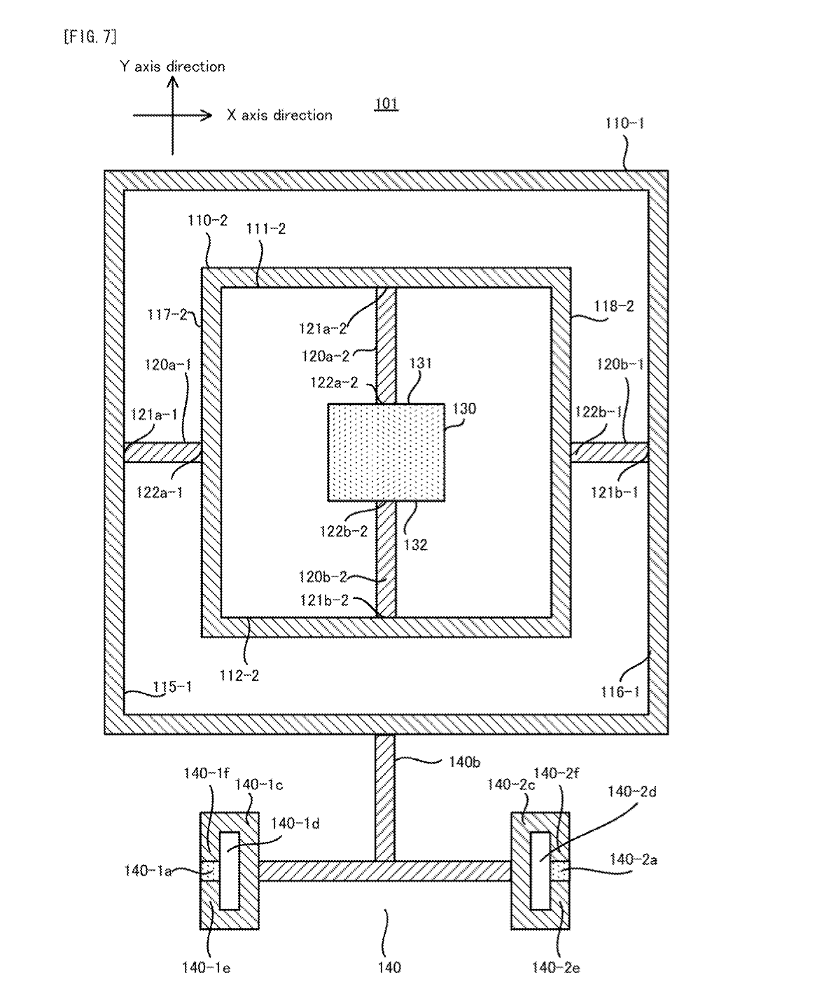

Next, with reference to FIG. 7, a second example of the MEMS scanner will be explained. FIG. 7 is a plan view conceptually illustrating a basic configuration of a MEMS scanner 101 in the second example. Incidentally, the same constituents as those of the MEMS scanner 100 in the first example described above will carry the same reference numerals, and the detailed explanation thereof will be omitted.

As illustrated in FIG. 7, the MEMS scanner 101 in the second example is provided with: the first base 110-1; the first torsion bars 120a-1 and 120b-1; the second base 110-2; the second torsion bars 120a-2 and 120b-2; the mirror 130, as in the MEMS scanner 100 in the first example. The MEMS scanner 101 in the second example is provided with a driving source part 140 which applies a force (microvibration) caused by a piezoelectric effect, instead of the driving source part 160 which applies the force (microvibration) caused by the electromagnetic force.

The driving source part 140 is provided with: a first piezoelectric element 140-1a; a second piezoelectric element 140-2a; a transmission branch 140b; a first support plate 140-1c which has a first space 140-1d and is fixed to the first base 110-1 via the transmission branch 140b; and a second support plate 140-2c which has a second space 140-2d and is fixed to the first base 110-1 via the transmission branch 140b. On the first support plate 140-1c, the first piezoelectric element 140-1a is sandwiched between first branches 140-1e and 140-1f facing to each other and defined by the first space 140-1d. On the second support plate 140-2c, the second piezoelectric element 140-2a is sandwiched between second branches 140-2e and 140-2f facing to each other and defined by the second space 140-2d. The application of a voltage to the first piezoelectric element 140-1a via a not-illustrated electrode changes the shape of the first piezoelectric element 140-1a. The change in the shape of the first piezoelectric element 140-1a causes a change in the shapes of the first branches 140-1e and 140-1f. As a result, the change in the shapes of the first branches 140-1e and 140-1f is transmitted to the first base 110-1 via the transmission branch 140b as the microvibration (or the wave-energy) detailed later. Similarly, the application of a voltage to the second piezoelectric element 140-2a via a not-illustrated electrode changes the shape of the second piezoelectric element 140-2a. The change in the shape of the second piezoelectric element 140-2a causes a change in the shapes of the second branches 140-2e and 140-2f. As a result, the change in the shapes of the second branches 140-2e and 140-2f is transmitted to the first base 110-1 via the transmission branch 140b as the microvibration (or the wave-energy) detailed later.

The microvibration applied from the foregoing driving source part 140 is the non-directional force explained with using FIG. 4. Therefore, the MEMS scanner 101 in the second example can enjoy effects which are same as various effects which the MEMS scanner 100 in the first example enjoys.

### (3) Third Example

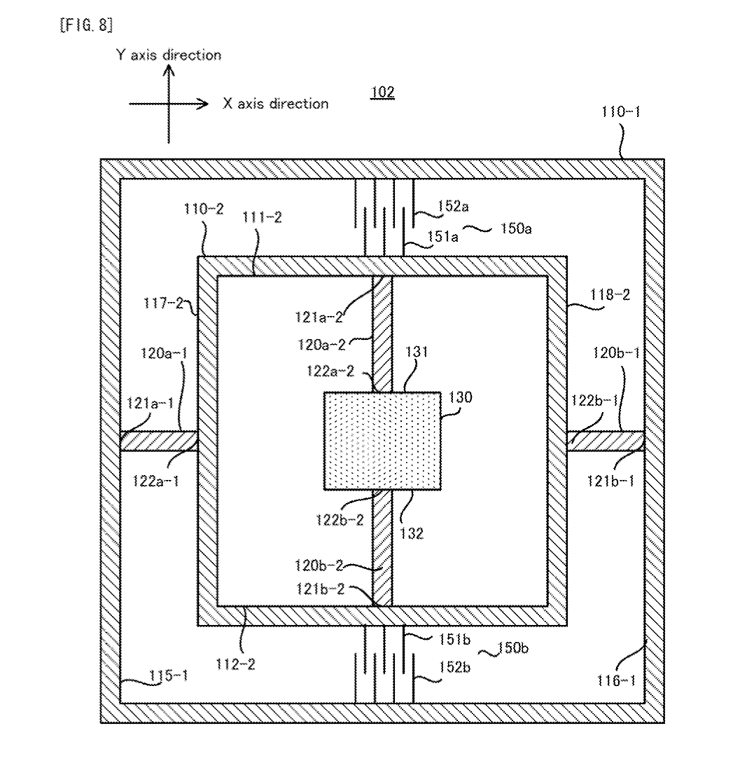

Next, with reference to FIG. 8, a third example of the MEMS scanner will be explained. FIG. 8 is a plan view conceptually illustrating a basic configuration of a MEMS scanner 102 in the third example. Incidentally, the same constituents as those of the MEMS scanner 100 in the first example described above will carry the same reference numerals, and the detailed explanation thereof will be omitted.

As illustrated in FIG. 8, the MEMS scanner 102 in the third example is provided with: the first base 110-1; the first torsion bars 120a-1 and 120b-1; the second base 110-2; the second torsion bars 120a-2 and 120b-2; the mirror 130, as in the MEMS scanner 100 in the first example. The MEMS scanner 102 in the third example is provided with a driving source part 150 which applies a force (microvibration) caused by a electrostatic force, instead of the driving source part 160 which applies the force (microvibration) caused by the electromagnetic force.

The driving source part 150 (150a to 150b) is provided with: a first electrodes 151a and 151b which are comb-like (or interdigitated) and are disposed along an outer side of the second base 110-2; and a second electrodes 152a and 152b which are comb-like (or interdigitated), are fixed on an inner side of the first base 110-1 and are distributed in such a manner that the first electrodes 151a and 151b and the second electrodes 152a and 152b interdigitate each other. Incidentally, the first electrode 151a and the second electrode 152a are disposed on a position which is same as a position where the above magnetic pole 162a is disposed. The first electrode 151b and the second electrode 152b are disposed on a position which is same as a position where the above magnetic pole 162b is disposed.

In this case, a desired voltage is applied to the first electrodes 151a and 151b (or the second electrodes 152a and 152b) in desired timing from a not-illustrated driving source part control circuit. Due to a potential difference between the first electrode and the second electrode, an electrostatic force (in other words, Coulomb force) is generated between the first electrode 151a and the second electrode 152a and between the first electrode 151b and the second electrode 152b. As a result, the electrostatic force is generated. This electrostatic force is transmitted to the second base 110-2 as the microvibration.

The microvibration applied from the foregoing driving source part 150 is the non-directional force explained with using FIG. 4. Therefore, the MEMS scanner 102 in the third example can enjoy effects which are same as various effects which the MEMS scanner 100 in the first example enjoys.

Incidentally, the MEMS scanner 100 in the first example to the MEMS scanner 102 in the third example can be applied to various electronic equipment such as a HUD (Head-Up Display), a HMD (Head Mount Display), a laser scanner, a laser printer, a scanning type driving apparatus, for example. Therefore, these electronic equipments are included in the scope of the present invention.

In the present invention, various changes may be made, if desired, without departing from the essence or spirit of the invention which can be read from the claims and the entire specification. A driving apparatus, which involves such changes, is also intended to be within the technical scope of the present invention.

### DESCRIPTION OF REFERENCE CODES

100-102 MEMS scanner
110-1 first base
110-2 second base
120-1 first torsion bar
120-2 second torsion bar
130 mirror
   140, 150, 160 driving source part

1. A driving apparatus comprising:
a first base part;
a second base part which is surrounded by the first base part;
a first elastic part which connects the first base part and the second base part and which has elasticity for rotating the second base part around an axis along another direction;
a driven part which is configured to be able to rotate;
a second elastic part which connects the second base part and the driven part and which has elasticity for rotating the driven part around an axis along one direction which is different from the another direction; and
an applying part which is configured to apply, to the second base part, an excitation force for rotating the driven part such that the driven part rotates while resonating around the axis along the one direction, at a resonance frequency determined by the second elastic part and the driven part,
the applying part being configured to apply the excitation force such that the second base part vibrates and deforms along the another direction and the deformational vibration becomes resonance,
the resonance frequency at which the second base part resonates being determined based on a resonance frequency of the driven part,
flexural stiffness of the second base part along the another direction becomes smaller than flexural stiffness of the second base part along the one direction.

2. (canceled)

3. The driving apparatus according to claim 1, wherein flexural stiffness of the second base part along the another direction becomes smaller than flexural stiffness of the second base part along the one direction by that the stiffness of one portion of the second base part becomes larger than the stiffness of another one portion of the second base part.

4. (canceled)

5. The driving apparatus according to claim 1, wherein flexural stiffness of the second base part along the another direction becomes smaller than flexural stiffness of the second base part along the one direction by that the mass of one portion of the second base part becomes larger than the mass of another one portion of the second base part such that.

6. (canceled)

7. The driving apparatus according to claim 1, wherein
the driven part is connected, via the elastic part, to a portion of the second base part which corresponds to a node of the deformational vibration,
stiffness of a portion of the second base part which corresponds to the node of the deformational vibration is larger than stiffness of a portion of the second base part other than the node of the deformational vibration.

8. The driving apparatus according to claim 1, wherein
the driven part is connected, via the elastic part, to a portion of the second base part which corresponds to a node of the deformational vibration,
mass of a portion of the second base part which corresponds to the node of the deformational vibration is larger than mass of a portion of the second base part other than the node of the deformational vibration.

9-12. (canceled)
